(19) United States
(12) Patent Application Publication
(10) Pub. No.: US 2005/0174540 A1
(43) Pub. Date: Aug. 11, 2005

(54) Mobile integrated visual projector (MIVP)

(76) Inventor: Demelash Mekuria, Atlanta, GA (US)

Correspondence Address: Demelash Mekuria, 409 Windmont Drive, Atlanta, GA, 30329, US

(21) Appl. No.: 10/775,976

(22) Filed: Feb. 9, 2004

(51) Int. Cl. G03B 21/00

(52) U.S. Cl. 353/13

(57) ABSTRACT

A projection device that can be installed in an automobile to project visual media in a way that the images reflect on the front glass through various manipulations (such as insertion of a concave device inside the two parallel panes of glass along or a slight tint on the inner pane glass) that give the window the properties of reflecting the projection image as well as keeping its transparency. The placement of the projection device can be placed in the car as an installed unit in the front headboard on the driver side or it can be a separate unit. The idea consists of the manipulation of the glass as well as the placement of the projection image.

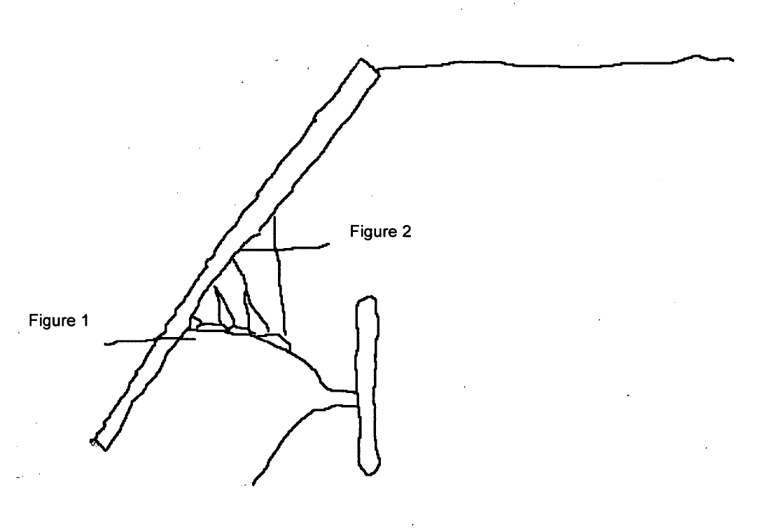

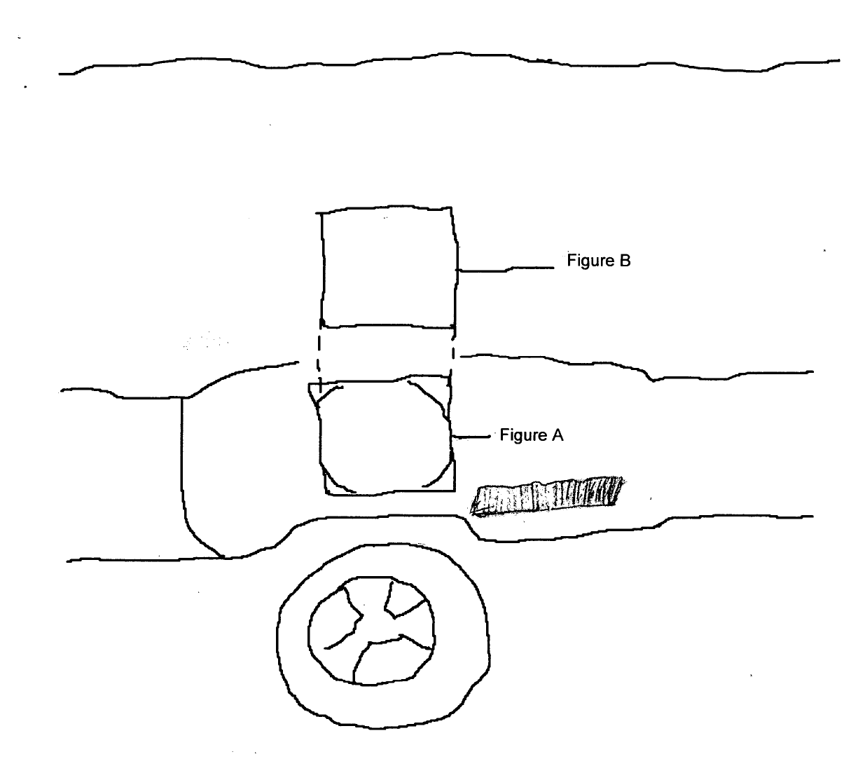

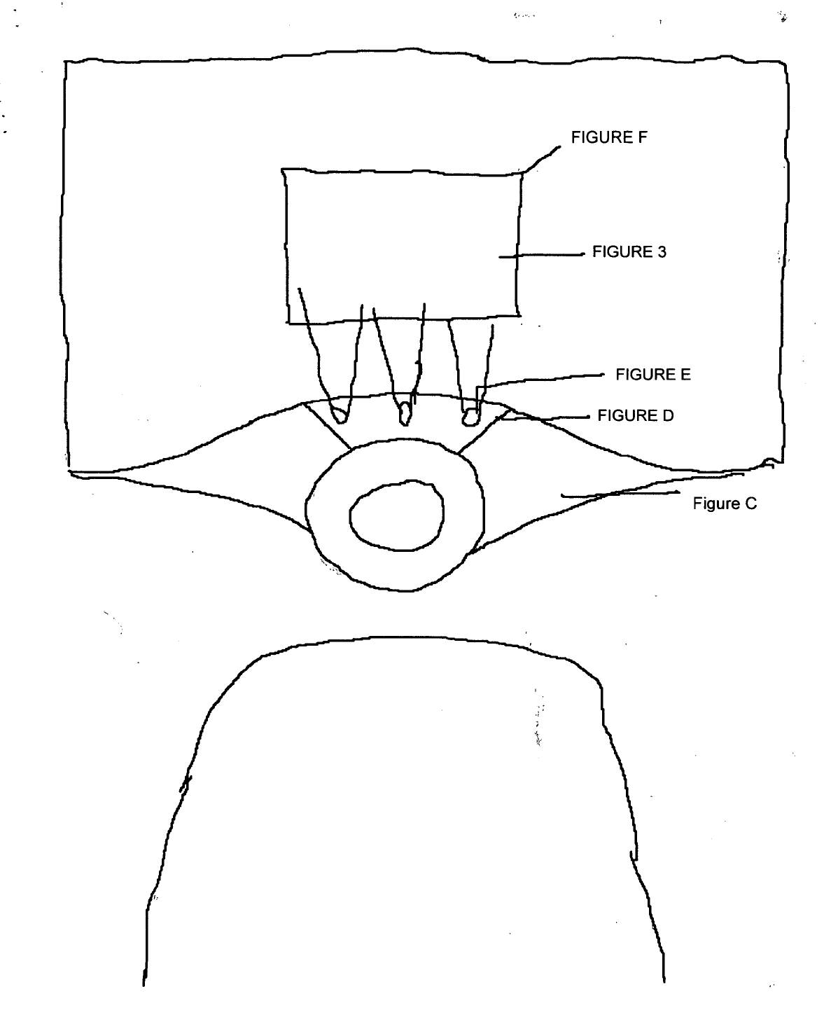

### CROSS-REFERENCE TO APPLICATIONS

The application in this patent can be applied to any automobile or mobile unit where glass is the barrier to the outside.

### BACKGROUND

### DESCRIPTION OF PRIOR ART

In the modern day society that we are used to in the area of transportation the driver can only communicate via audio means, however he cannot watch video media without risking the potential of a crash. It is because the eyes are important in reaching a destination and must be focus on the outside environment that he ore she surveys. Passengers have this advantage that they may watch video media and enjoy the comfort of being mobile. Televisions or monitors can be placed behind the head rest and even in the sun visors. However the focus is usually in the destination forward from the perspective of the driver. The driver's only means of watching visual media is to take the time to watch during brief moments of low traffic activity in a safe position. The prior art has never address the need for the driver to drive and simultaneously watch visual media in a much safer format than the media being displayed on the dashboards or in the headrest.

Visual media may have a safer and convenient way to be displayed to the driver where he may pay attention to the road as well as to visual media simultaneously. This is done by installing the projection image into the automobile where it may be displayed upon the glass in a way that does not interfere with the glass's transparent qualities to reflect the outside medium. The glass may display the visual media in a way that is more like looking at your reflection in a transparent glass with a certain tint. You can still see the outside but also you can see a slight reflection of visual media. The reflection of the visual media will be weaker than the actual images from the external environment giving the driver the choice to view the road or the visual media. With a low degree of multitasking the driver would be able to watch the media and the road at the same time.

The risk factor will be significantly reduced especially during times of heavy traffic where one is a standstill spot for the most part or at a long red light or even driving on a clear and straight road. Being able to view the media and the road at the same time gives the driver an comparative advantage over one who would try to watch in a different manner. This can reduce the stress of rush hour traffic and maybe make driving more enjoyable.

So you can see the road and the evening news at the same time, while driving! Imagine the relief to all night truckers who must stay awake for long periods of time on the road or taxi cab drivers or any driver stuck in traffic for long periods of time. This relieves the stress of driving and may even reduce road rage by causing less focus on the road. So the prior art only addresses the watching of visual media to the passengers and not to the driver in a safe manner.

### OBJECTS AND ADVANTAGES

Accordingly, several objects and advantages of my invention are the convenience and ease of use of any visual displayer. It can help out in emergencies or create entertainment in situations such as sitting in a drive through food lane or at a red light. It can also ease the stress of heavy congestion in traffic by keeping the viewer entertain while driving as well as allowing him or her to see when the car breaks in front of him. With roadside emergency vehicles it can be allow them to place their eyes on a map illustrating their destination while giving them the comfort of never taking their eyes off the road. With the MIVP driving, as we know it, will never be the same. The television can be an option just like the radio. Ambulance drivers can now know their destinations without flipping through a folded map. So there are two extremes of advantages of the MIVP, one being the ability to be entertain visually while driving in comfort and the other is being able to adequately handle emergency situations and reduce the risk of an accident or a delay in response.

### SUMMARY

This invention addresses the need for the driver to comfortably watch visual media and drive at the same time. Changing the placement of the visual media onto glass that can reflect the media images as well as keep its transparency allows this. The reflection presents itself and allows the driver to see the road. The road and the picture will blend in a contrast where the road will have dominance over the picture thereby allowing the driver to view images in a safer and comfortable manner. This can come in very useful with ambulances and cabs in viewing a map and the road at the same time. It can also brighten someone's day through entertainment.

### DRAWING DESCRIPTIONS

1. The projection device as it sits within the headboard of the car.
2. The window manipulated with a slight curvature to reflect the projection image.
3. An outline of an image displayed.
A. Another example of a projection device installed within the headboard of the car.
B. The result of that image upon the front windshield.
C. The headboard of a particular vehicle.
D. Projection unit that is apart of the head board unit.
E. The light projectors in the projection unit installed in the headboard of the automobile.
F. An outline is demonstrating an example image of a visual media.

### DESCRIPTION OF INVENTION

The first page of the drawing illustrates a side view of the invention from the driver side window. In the headboard there is a projection device apart of the headboard where the light projectors are buried inside the headboard to not interfere with the outer surface. This is shown in drawing number 1. The projection device shines a light upon a glass that is concave on the inner panel. The inner panel is represented by the numeral 2. 3 is an imaginary outline of an actual image on the inner surface of the glass showing the end result of the unit as a whole. The light intensity along with the inner panel tint is adjusted so that the image is displayed in a way that allows the windshield to keep its transparent qualities.

The 2nd page shows an alternate embodiment of the same idea except in a driver side view of the image. The project device is installed in the headboard as before except there is only one light doing the projection. The end result is shown in B, which could be a picture of any, kind. Again the outside still would have dominance over the image allowing the driver to comfortably view the image and drive at the same time. This is the safest way to constantly viewing a visual media while driving.

The 3rd drawing encompassing units C, D, E and F is an up close view of the projection image. The headboard, represented by C, has a slight curvature allowing it to run slightly parallel to the windshield where the glass is. D shows how the projection unit is integrated into the headboard so that it in a placement conducive to projection upon the front windshield. F is the example of the image by showing an outline of its borders. The outline illustrates the windshields inner concavity. The driver now can view the image and drive.

Operation of Invention:

The invention operates by taking advantage of the reflective qualities that the glass will have through manipulation of the internal and external glass surfaces. This manipulation need not be mandatory part of the idea however it is important that the image is displayed in such a way where the glass does not lose its transparency. This will also be accomplished by the projectors light intensity which should be set to lower than normal so that the image is displayed in a way that mimics a reflection on a transparent glass with a certain tint. The glass's ability to reflect a projection image while maintaining it's transparency allowing the driver to view the outside and another image simultaneously is enhanced by a tint differential between the inner and outer pane. The inner pane can have a darker tint than the outer giving the glass more reflective qualities while allowing light from the outside to come in. The tint from the inner glass can reflect the majority of the image decreasing its imprint on the outside panel. The outside panel can be used more for accepting the light from the outside world. The key is getting a combination of low intensity light where it can reflect on the panel in a way where it does not obstruct the transparency of the glass. So there is a clear distinction between the outside world and the images displayed on the inner and outer panel except that the outside world dominates in its view to the driver. So that in driving if a change happens then a reaction can happen immediately, especially in stop and go traffic situations. The basic components of the invention consists of the projector and its integration into the automobile via the headboard or elsewhere where it can be displayed onto the windshield. The other component is the windshield, which through manipulation can be adjusted to reflect the image and keep its transparency. This can be done by increasing the concavity and tint on the inner panel leaving the outside panel normal. The intensity of the light from the projector can also be adjusted so that the outside is for sure to dominate in the image projection.

### CONCLUSION RAMIFICATION AND SCOPE

Thus the reader will see that the unit's basic function is to project the image upon the front windshield without interfering with the driver's ability to see the road on the outside. This is accomplished by manipulation of the glass panel that has a concavity on the inner panel along with a darker tint on the inner than on the outer. The intensity of light from the projector can also be adjusted to decrease its interference with views from the outside. The object is to have the image displayed like a reflection in a looking glass so that reactions can be made to changes on the outside while viewing a visual media. This allows the reader the ability to see images as well as the road. Although this drawing represents 3 different embodiments the idea isn't limited to these descriptions. For example the projection unit may not be installed on the dashboard but elsewhere or the glass need not be concave. Thus the scope of the claim should be determined by the appended claim and it's legal equivalents.

1. A glass having a concave structure either inside or on the inner pane allowing it to have greater reflective qualities.

2. The glass in claim one with a tint on the inner pane that is darker than the outer pane.

3. A projection image installed in the headboard that projects visual media onto the said glass in claims 1 and 2.

4. A projection image installed in the headboard that projects visual media with a low degree of brightness that project the image onto a window while not ruining the window's transparent qualities.

5. A projection device that integrates into the automobile and facilitates the combination of watching visual media from the projection as well as driving.

6. A type of glass structure that is modified so it can reflect the projection's visual media however not losing its transparent capability. “For example a curvature can be made in the front of the automobile glass to increase its reflective or transparent qualities, or one side of the glass could contain a slight more tint than the other giving it more reflective qualities.”

7. A projection device that produces a range of low intensity light projection of visual media giving it the ability to project on transparent glass without letting the glass lose its transparent capabilities
